(19) United States
(12) Patent Application Publication
(10) Pub. No.: US 2006/0229402 A1
(43) Pub. Date: Oct. 12, 2006

(54) Essentially gas-impermeable thermoplastic sealant

(76) Inventor: Rajesh Kumar Varma, McHenry, IL (US)

Correspondence Address: Alfred D. Lobo, Esq.;LOBO & CO., L.P.A., 933 The Leader Building, 526 Superior Avenue, Cleveland, OH, 44114-1401, US

(21) Appl. No.: 11/446,953

(22) Filed: Jun. 5, 2006

Related U.S. Application Data
(63) Continuation-in-part of application No. 10/074,070, filed on Feb. 12, 2002, now Pat. No. 7,056,971.
(60) Provisional application No. 60/268,461, filed on Feb. 13, 2001.

(51) Int. Cl. C08K 5/01

(52) U.S. Cl. 524/490

(57) ABSTRACT

A thermoplastic essentially oxygen-impermeable plasticized sealant is formed by melt-blending a hydrogenated styrene-conjugated diene-styrene (SMS) block copolymer rubber with a polystyrene-polyisobutylene-polystyrene (SIBS) block copolymer rubber and a polyolefin plastic with a liquid polyisobutylene (PIB) oil plasticizer provided the PIB oil is present (i) in the range from 5% to less than 50% by weight of the sealant and (ii) in relation to total rubber, in the range from 0.3 to 0.8. The required minor amount of PIB oil, relative to total rubber, in combination with SIBS present in a minor amount relative to the amount of plasticized sealant, provides the sealant with unexpectedly better oxygen barrier properties and load bearing at 82° C. (180 ° F.) than a comparable blend of SIBS with mineral oil; the sealant is also essentially free of tack, adhesive properties and oil-bleed, with essentially no detackifier present. The PIB-oil plasticized SIBS sealant has a haze of less than 15%; a composite made by melt-bonding a core layer between polyC₂-C₃olefin sheets, maintains a haze less than 14%. The plasticised sealant is particularly useful for sealing elements for containers in which foods, beverages and medical products must be preserved for a long period.

### CROSS-REFERENCE TO RELATED APPLICATION

This application is a continuation-in-part application of Ser. No.10/074,070 filed 12 Feb. 2002 which was filed subsequent to provisional application No. 60/268,461 filed Feb. 13, 2001.

### FIELD OF THE INVENTION

An elastomeric seal, held inside a removable cap (a seal for a bottle cap is narrowly referred to as a “cap liner”), is conventionally thermoformed from a thermoplastic elastomer (referred to as a “TPE”) to prevent escape of any portion of the contents of the container, and to prevent contamination of the contents from the environment due to permeation of a gas through the TPE. A laminar sheet of such a TPE is also used as a “core layer” in a laminate used to form a container. The term “elastomer” is used herein to refer to a synthetic resinous material having elasticity such that a test strip 2.5 cm wide and 2.5 mm thick may be stretched in the range from 5% to 100% of its initial length and still return to its original length; further, such elastomer is necessarily thermoplastic and re-processable.

The Problem:

The problem is to provide a thermally deformable, typically an injection-moldable, or extrudable, soft and flexible, essentially gas-impermeable TPE sealant usable as (i) a liner having a thickness in the range from about 1 mm to 10 mm, melt-bonded to a synthetic resinous cap, typically polypropylene; (ii) a cork for a wine bottle; or (iii) a core layer of a composite film formed by melt-bonding a skin layer of a polyolefin resin to each side of the core layer. A “flexible” sealant is one which has a hardness in the range from Shore A 35 to less than 80; such flexibility of a typical sealant is demonstrated by an extruded rod 6.35 mm (0.25 in) in diameter requiring a force no more than 25 kg (55.1 lb) to bend it over a 2.54 cm diam (1.00 in) mandrel, to form a 90° L. The composite film is to have an optical haze of less than 25%, preferably less than 15% (ASTM D1003).

The sealant is required to be melt-bondable to PP having a MFI in the range from 1-12 gm/10 min at 230° C. and 2.16 Kg load, yet be essentially free of tack or adhesive properties, and essentially free of detackifier, so that a cap with the sealant as cap liner has an acceptably low removal torque less than 50 in-lb. The sealant is also necessarily essentially free of noticeable “oil-bleed” despite containing enough plasticizer to allow the blend to be melt-extrudable without thermal degradation.

It is essential that the seal have an oxygen permeation rate less than about 12,000 cc.(2.54 μm)/m².day.atm, preferably in the range from about 5000-8,000 cc.(2.54 μm)/m².day.atm, to provide an effective barrier against the permeation of a deleterious gas through it for at least a year, yet be relatively soft having a hardness in the range from Shore A 35 to less than 80 (ASTM D 2240-86). The soft sealant is also to have a compression set in the range from 15-25% @ 23° C./22 hr, and 40-70% @ 70° C./22 hr, the compression set being measured by ASTM D 395-03 Test Method B.

By “essentially gas-impermeable” is meant that the sealant has an oxygen-permeation rate of less than 12,000 cc.(2.54 μm)/m².day.atm, as measured with a Mocon Instrument as described in greater detail below. A comparable measurement may be made by the procedure described in ASTM D 3985-81 but the value for an equivalent oxygen permeability has not been determined. Permeability is the permeation rate normalized for a 1 mil (2.54 μm) thickness and 1 atm. Thus, the aforesaid permeation rate is the same as a permeability of 12,000 cc./m².day (i.e. cm³ per m² per day).

By “essentially free of adhesive properties” is meant that in a Standard Test Method for Strength Properties of Adhesive Bonds in Shear by Compression Loading (ASTM D 905-03), except that upon removal from pressure, the wood blocks are conditioned at 130° C. for 30 min. The wood blocks can be easily manually pulled apart. A more germane test, if less accurate, is that a film, 25.4 μm (1 mil) thick, of the cooled melt-blended sealant, held under 344.5 KPa (50 lb/in²) pressure between two wooden blocks for two hours at room temperature (22° C.), allows the wooden blocks to be manually readily pulled apart with a force of less than 5 kg (11 lb). Nevertheless, the sealant is melt-bondable to a laminar surface of 1-12 MFI polypropylene.

By “essentially free of noticeable oil bleed” is meant that when a sheet of the sealant, 5 cm ×5 cm×1 cm thick, is placed on VWR brand No. 413 White Smooth filter paper and removed after 1 hour, the impression of the sheet on the filer paper is not visible to the naked eye.

By “essentially free of tack” is meant that in a Standard Test Method for Tack of Pressure-Sensitive Adhesive by Rolling Ball (ASTM D 3121-05), a steel slide 48 mm (2 in) wide and 380 mm (15 in) long is coated with a film melt-blended at 130° C. for 30 min, which is then cooled. The released ball does not stop on the cooled film. The film remains essentially free of tack under 100° C.

By “essentially free of detackfier” is meant that the sealant contains less than 1 part of detackifier per 100 parts of “finished” or blended sealant, preferably no detackifier.

### BACKGROUND OF THE INVENTION

The aforementioned parent application Ser. No. 10/074,070, the disclosure of which is incorporated by reference thereto as if fully set forth herein, disclosed a plasticized sealant to replace conventionally used seals in a removable closure means for sealing containers. Despite the effectiveness of sealing elements made with the ingredients disclosed in the aforesaid '070 application, the search for an even more effective plasticized sealant continued.

The parent '070 application disclosed that a plasticizer of liquid polyisobutylene (“PIB”) oil, in combination with either (a) a vinylaromatic (S)-polyolefin (M)-vinylaromatic (S) polyblock copolymer, or (b) a thermoplastic vulcanizate (TPV), and from 1% to 20% of detackifier, provides a sealant eminently adapted for use as an oxygen barrier. In the hydrogenated vinylaromatic-conjugated diene block copolymer (SMS), the midblock M was olefinic, having from 2 to 4 carbon atoms; for example, a SBS block copolymer derived by hydrogenation of a styrene(S)-conjugated diene (B)-styrene (S) block copolymer. The PIB oil is commercially available as a copolymer of isobutylene and butene, the butene being in a minor (less than 50%) molar proportion (this copolymer and the homopolymer are together referred to herein as liquid “PIB oil”). PIB oil, preferably a copolymer of about 90% isobutylene, the remainder being butenes, is conventionally used as a plasticizer and tackifier. It is therefore surprising that a large amount of PIB oil in combination with rubbers and plastic, specifically polypropylene (PP) or polyethylene (PE), allows making a sealant which is essentially free of detackfier.

Pure isobutylene homopolymer, that is, with no butene in it, when incorporated by cationic polymerization in a mixed solvent such as methylene chloride and methylcyclohexane at about −65° C. in the presence of a Lewis acid such as titanium tetrachloride, as a midblock of PIB homopolymer in a triblock copolymer with polystyrene ends, provides a styrene-isobutylene-styrene (“SIBS”) block copolymer which is known to have excellent barrier properties against gases. However it was not expected that when SIBS is used in a specified range with PIB oil, in combination with a SMS block copolymer and PP or PE, the SIBS could form an essentially homogenous blend with the desired properties. By “an essentially homogenous blend” is meant that the components of the multi-phase mixture are so intimately and uniformly mixed as to have less than a 10% variation in morphology from one zone to another, thus mimicing a miscible blend. In particular, the peaks for the glass transitions of the SMS and SIBS block copolymers are partially overlapped.

Though a SIBS triblock addition polymer, for example, commercially available as Sibstar® from Kaneka Tex., has excellent barrier properties, SIBS, per se, has an unsatisfactorily high compression set above 70% at 70° C. (135° F.) and it has too low a modulus. Its physical properties are unlike crosslinked PIB rubber of the same number average molecular weight (Mn), which has much better thermal stability and much higher modulus because it typically includes about 5% polyisoprene.

### SUMMARY OF THE INVENTION

A SIBS block copolymer plasticized with PIB oil has surprisingly better barrier properties than the same amount of SIBS plasticized with mineral oil substituted for the PIB oil in the same amount by weight.

The foregoing discovery is used to formulate an elastomeric sealant of a substantially fully hydrogenated SBS block (SMS) copolymer in combination with SIBS, the combination being plasticized with PIB oil; the weight ratio of PIB oil/total rubber is in the range from about 0.2 to 1.5; the weight ratio of SIBS/total rubber is in the range from about 0.2 to 0.75; and, the ratio of PIB oil/SIBS is in the range from about 0.3 to 5; the PIB oil and SIBS are each present in a minor amount (by weight) relative to total weight of plasticized sealant (including the SIBS, SMS, PIB oil, polyolefin and additives), that is, from about 5—less than 50% by wt, preferably from about 10 to 40% by wt. By “substantially fully hydrogenated” is meant that at least 85% of the double bonds in the unhydrogenated midblock are hydrogenated.

The plasticized sealant is an essentially homogeneous blend having an optical haze in the range from 1 to less than 25%, preferably 1 to 15%, which blend provides unexpectedly good resistance against oxygen permeability while being essentially free from oil bleed and tack, provided the sealant includes at least 10% but no more than 70% by wt (based on wt of sealant) of polypropylene (PP) and/or polyethylene (PE).

Further, despite the amount of PIB oil, the sealant is tack-free though the sealant includes less than 1% by weight of a detackifier, based on wt of blended sealant, preferably none. The novel sealant has a lower oxygen permeability than a substantially similarly plasticized elastomeric sealant in which the only rubber present is SMS (see Table 3, below, A3 and D3). The amount of PP and/or PE in the sealant, in the range from about 5% to 35%, preferably 15% to 20%, is critically important to allow hot flowable sealant to form a cohesive bond with a polyolefin surface.

A blend of the foregoing SBS, SIBS, PP and PIB oil is formed into a shaped article of arbitrary shape and thickness, most commonly a thickness in the range from about 0.1 mm to 50 mm depending upon whether it is for a laminar seal, a liner, core layer, or a cylindrical cork. As a liner, the blend may be thermoformed for general use as a seal in a removable closure means, or into a collapsible liner for a container, for example, a bag for a fiber drum. The PIB oil is selected from a homopolymer of isobutylene and a copolymer of isobutylene and butene, the butene being in a minor molar proportion, typically about 90% isobutylene, the remaining being butenes. Though the blend may typically include an antioxidant, antiozonant, heat stabilizer, processing aid, and other additives known in the art to enhance the useful life of the blend, in an amount together less than 5% by wt, the sealant is preferably free of an inert filler. However, a small amount, preferably less than 5% by wt, of filler particles smaller than about 44 μm may be added to provide a higher bulk density and/or opacity, if desired.

The novel blend has the following essential properties: an oxygen permeability less than 12,000 cc/m².day, preferably in the range from 5,000-8,000 cc/m².day; a compression set in the range from 40-70% measured at 70° C. after 22 hr; hardness in the range from 35 to less than 80 Shore A; and, maximum removal torque of no more than 50 in-lb, preferably in the range from 5-40 in-lb.

A minor proportion by weight of a SIBS triblock (e.g. Sibstar®), relative to the weight of the blended novel PIB oil-plasticized sealant, provides an unexpectedly disproportionate boost of barrier properties of the PIB oil-plasticized SMS sealant disclosed in the '070 application. It is essential that this combination of SIBS and PIB-oil be used in the sealant because no such unexpected boost is evident when the SIBS is used in combination with a mineral oil plasticizer. The barrier properties of the sealant may be increased with a major proportion by weight of the SIBS, but such a blend with acceptable hardness is typically unacceptably tacky.

Preferably, the amount of PIB oil has a number average molecular weight (“Mn”) in the range from 200 to 6000, most preferably from 300-2000, and is used in a minor amount, that is, in the range from about 10% to less than 50% by wt of blended sealant, most preferably from 25-45%.

The preferred SMS results in a triblock with a hydrogenated C₂-C₄ olefin midblock. Thus hydrogenated styrene-butadiene-styrene (SBS) results in a triblock of “polystyrene-b-poly(ethylene/-butylene)-b-polystyrene” or “SEBS”; hydrogenated styrene-isoprene-styrene (SIS) results in a triblock of “polystyrene-b-poly (ethylene/propylene-3-methylbutene)-b-polystyrene” or “SEPS”; hydrogenated poly(styrene-b-isoprene/butadiene-b-styrene) (SI/BS) results in a triblock of “polystyrene-b-poly(ethylene-ethylene/propylene)-b-polystyrene” or “SEEPS”.

The SIBS block polymer has a number average molecular weight Mn in the range from about 50,000 to 500,000 with the weight ratio of styrene to isobutylene ranging from 5/95 to 37/63, preferably 13/87 to 35/65. When blended with SMS and the PIB oil, a soft seal is provided having a hardness in the range from Shore A 35 to <80; the seal is essentially gas-impermeable so long as the gas exerts a pressure of less than about 3 atm (or bar). Though the pressure does not affect permeability, the permeation rate at 3 atm is high enough to require an uneconomically thick seal to provide the desired barrier against oxygen permeation. An oxygen-permeability of less than 12,000 cc./m².day at 23° C. is deemed much better than a currently acceptable 12,000 cc./m².day at 23° C. for good shelf life of food products such as fresh orange juice.

The SIBS preferably has a Mn in the range from 70,000 to 130,000, a hardness in the range from Shore A 30-100, tensile at 100% elongation in the range from about 0.5 to 10 MPa and specific gravity in the range from 0.9 to 0.99. Preferably the ratio of SMS:SIBS in the blend is in the range from about 100:30 to 100:300 parts by weight, most preferably from about 100:35 to 100:200 parts by weight. The SMS preferably has a Mn in the range from about 40,000 to 500,000, with the weight ratio of styrene to hydrogenated olefin ranging from 13/87 to 37/63, preferably 25/75 to 35/65.

The sealant may be used with or without a cooperating closure means removably disposed in sealing engagement with a container. When used as a sheet from about 50 μm to 5 mm thick to to line an entire sealable container, the removal torque f is not an issue but a hardness of Shore A 80 or above is not adequately flexible. When formulated with a hardness of 79 Shore A, the load bearing ability of the blend may range up to 6.89 MPa (1000 psi) at 82° C. (180° F.), so that blends may be formulated with a load bearing ability in the range from about 345 kPa to 6.89 MPa while having a hardness in the range defined above.

It is essential that the amount of PIB plasticizer used be sufficient, relative to the amount of SMS, so as to render the PIB-plasticized SMS-blend usable as a seal, but not so much that the blend may be usable as an adhesive. When the amount of PIB oil causes the seal to adhere slightly or have noticeable tack, such adhesion or tack is negated by adding less than 1% by weight of an appropriate detackifier to the blend. The presence of the specified amount of SIBS and PIB oil in the blend avoids both oil-bleed and the use of larger amounts of detackifier.

### BRIEF DESCRIPTION OF THE DRAWING

The foregoing and additional objects and advantages of the invention will best be understood by reference to the following detailed description, accompanied with schematic illustrations of preferred embodiments of the invention, in which illustrations like reference numerals refer to like elements, and in which:

FIG. 1 is a perspective view diagrammatically illustrating a prior art bottle cap in which a cap liner molded using the blend of this invention, is snugly fitted within the periphery of the cap.

FIG. 2 is a fragmentary sectional view of FIG. 2 showing how permeation rate is reduced to being negligible by requiring gas to traverse the vertical distance of the side walls of the cap.

FIG. 3 is an isometric view diagrammatically illustrating a molded plug or “cork” such as is conventionally used to cork a wine bottle.

FIG. 4 is a elevational cross-section view of another embodiment of a conventional molded stopper or “cork” for a wine bottle.

FIG. 5 is an elevation view of a metal closure for a syringe vial over the mouth of which the closure is secured in essentially gas-tight relationship.

FIG. 6 is a top plan view of the metal closure of FIG. 5.

FIG. 7 is a graph plotting the oxygen permeability of (i) 100% SIBS and 0% mineral oil plasticizer at one end and (ii) mineral oil plasticized SMS and HDPE at the other.

FIG. 8 is a graph plotting the oxygen permeability of two blends of SIBS and SMS with PIB oil and PP (dashed line) in a comparison similar to that shown in FIG. 7.

FIG. 9 is a cross-sectional view diagrammatically illustrating a composite film having three layers including a core layer and two skin layers, one bonded to each side of the core layer.

### DETAILED DESCRIPTION OF PREFERRED EMBODIMENTS

Moisture, inorganic gases such as oxygen, carbon dioxide, sulfur dioxide, ammonia and nitrogen, and organic gases such as methane and ethylene are among common gases which tend to leak either into or out of inadequately sealed containers and deleteriously affect contents of the containers because of the reactivity of the gases over a long period. Leakage of air into a container results not only in contact of oxygen with the product but also growth of living organisms such as bacteria. Oxygen is the most common detrimental gas because most solid and liquid foods are oxidized over time. Products are therefore sealed against leakage of such gases into the containers. Where a product is sealed under nitrogen, it is desirable to prevent the nitrogen from escaping. Thus the blended TPE is useful to form seals for bottle caps whether of the pressure-crimped or screw-on type; and for liners of cartons which by themselves are highly permeable to gases even under atmospheric pressure, but which cartons provide the mechanical strength to contain the product therewithin. A most desirable blend has an oxygen-permeation rate in the range from about 4,000 to 8,000 cc.(2.54 μm)/m².day.atm at 23° C., and sealing elements made from the blend exhibit excellent resistance to transmission of carbon dioxide, nitrogen, water vapor.

Sealing a container against leakage of a liquid under relatively low pressure, in the range from about 1 to 3 atm (or bar), either into or out of the container, is a relatively trivial problem compared to providing an essentially gas-tight and penetrant-impermeable seal under the same pressure.

All containers are configured so as to be sealed to minimize the leakage of gas which then becomes trapped in contact with the gas-sensitive product held in the container. Oxygen-containing gases, and molecular oxygen and carbon dioxide in particular, are known to affect the storage life of a fruit juice or drug adversely, despite such ingestibles being tightly sealed in a glass container with a conventional TPE seal. For example, permeation of oxygen through a seal is detrimental to fresh fruit juice even when the containers are stored under atmospheric pressure. The permeation rate increases with pressure. An inert gas blanket which may be sealed in a container at a pressure up to about 2 atm (atmospheres or bar) may be lost through the conventional seal in a tightly secured cap over a period less than six months.

Sealing elements or closure liners for closures are typically molded closures which include twist crowns, crown corks, stoppers, septums for syringe vials, screw caps for bottles jars and the like but may also be gaskets; many of these are made by in-shell or out-shell molding and gaskets may also be cast in-situ.

An effective seal provides both, an adequately low permeation rate and also an adequately low transmission rate. Factors which affect permeation rate are temperature, relative humidity, material thickness, pressure which is usually barometric pressure, and time. Transmission rate is measured as leakage of cc/day and depends both on permeability and thickness; it is affected by the same factors. The lower the permeation rate, the lower the transmission rate for a specified thickness, and the better the barrier properties. A sealant cap liner having hardness, compression set and oxygen-permeability in the specified range, no oil bleed and free of tack is required to have a maximum removal torque of 50 in-lb. A TPE having sufficiently low gas-permeability will ensure that the contents of the container will have a desired greatly extended shelf-life relative to the shelf-life obtained with currently used TPE seals, but will not provide a solution to the problem if the TPE has unacceptable compression set and removal torque, or tears when either compressed or the cap removed.

For in-shell molding, most commonly used, granules of blend are fed into an extruder and a rotating blade cuts the extrudate into a pellet which is dropped into the bottle cap or other closure. The extrudate does not adhere to the blade and the pellet, and because of its low “tack”, is easily positioned in the cap. A “tacky” blend is one which, when extruded, adheres to the blade. In out-shell molding, the pellet is formed outside of the closure, on a “puck”; the pellet is then positioned in the closure and molded into its final shape. After cooling and hardening of the plasticized sealant, it is critical that the shaped seal forming the cap liner, typically in the range from about 127 μm to 2 mm thick, be soft enough to be compressible, but no more than about 5 mils, yet hard enough to withstand the pressure exerted by tightening a cap with 20 in-lb force, without tearing.

It is well known that an essentially gas-impermeable adequately soft and thin TPE cannot now be injection-molded in conventional injection-molding machines economically. Known TPEs which have oxygen-permeability less than 12,000 cc /m².day, such as butyl rubber, typically have a hardness greater than Shore A 80 and are too hard to provide a readily usable TPE seal. A usable TPE seal is defined as a relatively soft rubbery synthetic resinous material required to have a hardness in the range from Shore A 35 to <80 and lower than the aforestated oxygen-permeability.

There is need for a practical, readily deformable, sufficiently oxygen-impermeable sealant which would provide an effective barrier against permeation of oxygen through a removable seal, whether a generally cylindrical cork having an axial length in the range from about 10 mm to 50 mm, or a composite film having a core layer of sealant 0.5 mm to 10 mm thick in cross-section, over a long period of time in the range from about 1 to 10 years.

It is self-evident that a conventional SMS seal in a sufficiently very large thickness (cross-section) will provide an excellent barrier to transmission of gas, but it is equally self-evident that it is impractical and uneconomical to provide a seal or a liner in such sufficiently very large thickness.

The '070 application teaches that a blend of SBS and the PIB plasticizer results in too low a melt viscosity, and so soft and deformable a composition that it does not provide a “basic blend” suitable for a satisfactory “basic seal”. To provide desirable properties for a basic blend usable as a removable seal, it was necessary to “harden” a too-soft and therefore unusable composition without sacrificing its homogeneity. By “unusable” is meant that pressure exerted by a cap on the seal causes the cross-section of that portion of the seal in contact with the cap to decrease more than 20% because the TPE is too soft; or, that pressure exerted by the cap fails to provide a gas-tight seal at the mating surfaces of seal and container because the TPE is too hard. It is now practical to blend a sufficient amount of a SIBS block copolymer with a plasticized SMS to provide a blend with a combination of desirable hardness, preferably in the range from about Shore A 50 to Shore A 75, with the aforespecified oxygen-permeability. To obtain the required hardness and compression set the SMS and SIBS are melt-blended with the specified amount of hardener or a melt index modifier which is compatible with the PIB-plasticized blend of SMS and SIBS. Most preferably the hardener contributes to enhancing oxygen-barrier properties rather than diminishing them, that is, rather than increasing oxygen-permeability. The amount of polyolefin hardener is minimized or zero if a SMS and a SIBS having the appropriate hardness are selected.

The SMS Elastomer:

It is essential that the deformable PIB-plasticized SMS/SIBS blend be “soft” as stated above, and stable to degradation under storage conditions for at least one year.

SMS copolymers which satisfy these conditions are preferred starting materials. Techniques for their preparation are well known in the art. See the text “Block Copolymers” by D.C. Allport and W.H. Janes, Applied Science Publisher Ltd., London (1973). Though tetrablock and higher block copolymers may be used, a triblock copolymer with styrene end-blocks (“S-blocks”) having Mn in the range from about 50,000 to 500,000 is uniquely adapted for the purpose. When the M-block is polyolefin, the olefin is most preferably isoprene, butadiene, ethylene, propylene, and/or butylene, and the M-block has Mn preferably in the range from about 50,000 to 700,000. Most preferred is a triblock copolymer in which the ratio of M-block/S-block is in the range from 20/80 to 40/60.

Hydrogenated triblock copolymers are commercially available from Asahi, Kurary, Dexco and Phillips, for example as Kraton G 1650, Kraton G 1651, Kraton G 1654, Septon 8004, Dynaflex GS6771-000, Dynaflex GX6768-1000, and the like.

The Plasticizer:

Since polyisobutylenes having Mn lower than 500 are found to be relatively ineffective to decrease oxygen permeability significantly, polyisobutylenes having Mn greater than 500 but lower than that at which the polybutylene is a solid at 100° C. are preferred. Commercially available Indopol H-1500, Panalene H-300E and Indopol L-100 polybutylenes are essentially homopolymers of isobutylene having Mn in the range from about 1000 to 5000 which are most preferred, though copolymers which have a small enough butylene content, less than 40% of the copolymer, typically from about 1 to 20% may also be used if fluidizable during melt-blending of the ingredients at a temperature in the range from about 150° C. to 250° C.

Such a PIB-oil plasticizer through which air under pressure, sufficient only to overcome the hydrostatic head of liquid, may be bubbled at ambient temperature of 23° C., is miscible with both the SMS and the SIBS.

The Detackifier:

When the basic blend is tacky it is detackfied with less than 1% by weight of a detackifier, an amount which will not affect other desired physical properties measurably. Fatty acid amides, waxes and metal stearates are commonly used detackifiers which bloom to the surface, and preferred is a liquid which fails to contribute a Tg to the detackified blend, such as a silicone oil or epoxidized vegetable oil, typically epoxidized soybean or castor oil.

The Polyolefin Melt Index Modifier or Hardener:

In addition, when a minor amount of SIBS, less than 50% by wt of the blend, is used, it is desirably combined with sufficient “polyolefin hardener” to provide desirable properties other than gas impermeability. The polyolefin melt index modifier or hardener is preferably a commercially available homopolymer of ethylene or propylene, the polyethylene having a melt index in the range from 0.2 to 100 gm/min to 0.5 to 50 gm/10 min @ 190° C. (ASTM D1238) preferably being high density PE (HDPE), and the polypropylene having a melt index in the range from 1 to 200 gm/10 min to 2 to 100 gm/10 min @ 230° C. To tailor the properties of the blend further, from 0 to 20 phr of a polymono(C₂-C₄) olefin rubber having Mn in the range from 200,000 to 1,000,000, may be used. The term “homopolymer” as used herein refers to a polyolefin containing no more than 10 mol % of a comonomer.

Additional Modifiers:

The desired product may include fillers, processing aids, stabilizers, antioxidants and release agents such as a fatty acid amide, e.g. stearyl stearamide, in an amount less than 5% by weight of the sealant.

To make a preferred sealant, 100 parts of SMS are melt-blended with from about 120 to 200 parts PIB fluidizable during melt-blending, from about 30 to 250 parts of SIBS, and from about 20 to 200 parts of PE or PP depending upon the melt index. The ingredients may also be melt-blended with a conventional blowing agent to provide a cooled sealant having a bulk density in the range from about 0.5 to 0.8 g/cc.

The SMS triblock copolymer and SIBS are preferably so that they exhibit partially overlapping Tgs in the blend.

In the illustrative examples set forth in the following Tables, percentages (%) are based on the total weight of blended sealant, and references to “parts” are to “parts by weight”. All blends were produced in a 2″ diameter staged, single step twin-screw extruder in which three zones in the barrel were maintained at temperatures in the range from 160° C. to 200° C. in the first zone, 170° C. to 200° C. in the second zone, and 180° C. to 200° C. in the third zone. The time during which the blend stayed in the barrel range from about 30 sec to 10 min.

In the following Table 1 are set forth data quantifying the effect of plasticizing SIBS (ranging from 0 to 100%) with mineral oil. The points set forth permeation rates for SIBS (Sibstar 103T-F) alone, and for formulations of SIBS, SMS (Septon 8006), and high density polyethylene(HDPE) plasticized with mineral oil. The HDPE is used to get approximately the same hardness. The amounts of SIBS are chosen near the mid-point of the range, where substantial deviation is expected, to determine how closely the actual permeability matched the expected permeability (the straight line in the graph).

TABLE 1

| Ingredient, % | A1 | B1 | C1 | D1 | E1 |
|---|---|---|---|---|---|
| Septon 8006 | | | | 4.6 | 28.9 |
| Drakeol 500 | | 23.7 | 23.5 | 33.8 | 54.9 |
| Nova HDPE | | 23.7 | 17.6 | 26.9 | 16.2 |
| 2724 | | | | | |
| melt flow | | | | | |
| index 54 | | | | | |
| Sibstar ® | 100 | 52.6 | 58.8 | 34.6 | 0 |
| 103T-F | | | | | |
| Hardness, | 49 | 59 | 62 | 60 | 58 |
| Shore A | | | | | |
| O₂ Permeation | 3,900 | 23,500 | 20,000 | 29,500 | 55,000 |
| rate, | | | | | |
| cc.(2.54 μm)/ | | | | | |
| m² · day · atm | | | | | |

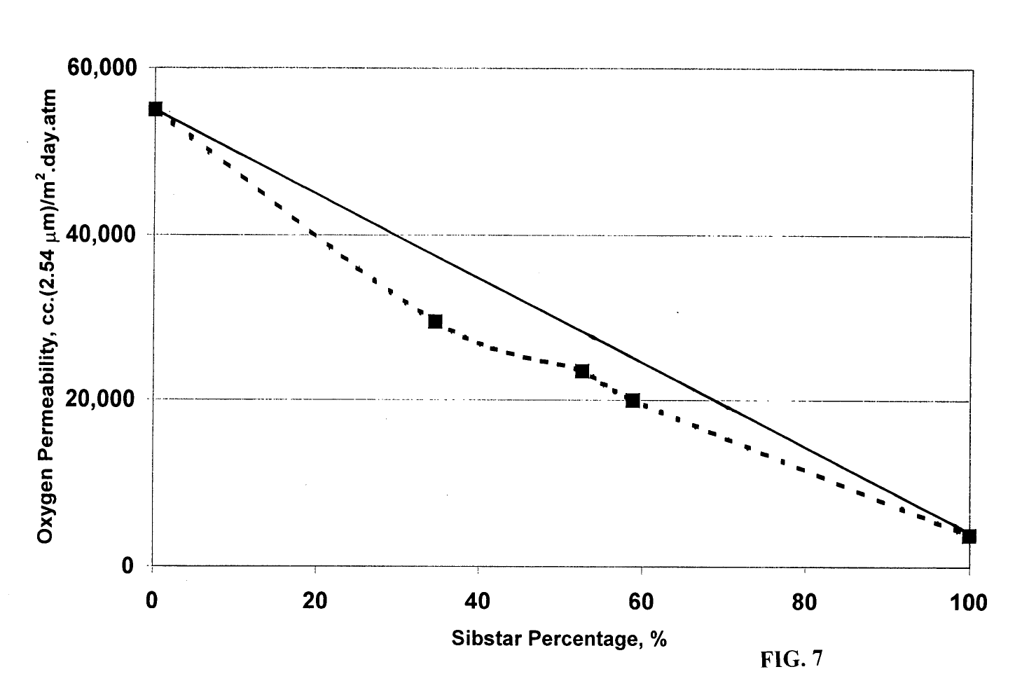

Permeation rates of the foregoing formulations are plotted in FIG. 7. It is evident that the permeation rate is directly related to the concentration of mineral oil in accordance with what is expected, shown by the straight line. The points (marked by squares) for blends with SIBS and equal amounts of mineral oil, near the mid-point of the straight line connecting the end points, nearly fall on the line as one would expect. The formulation for 0% and 34.6% Sibstar are blended with SMS to provide a solid rubber with comparable hardness. The SMS used, Septon® 8006 (SEBS from Kuraray) has a permeability of 35,000 cc.(2.54 μm)/m².day.atm at 23° C., indicating barrier properties nearly ten times worse than SIBS, so that the presence of SMS in the blends at the two points would not contribute significantly to their barrier properties. HDPE is added to adjust the viscosity of the blend in the extruder and the hardness and compression set of the cooled blend. HDPE is present as a dispersed phase and in small amounts. Since the difference in the amount of HDPE present in each of the three blends is very small, that difference contributes no significant barrier to diffusion of oxygen.

In the following Table 2 are set forth permeation rates for SIBS (Sibstar 103T-F) alone, and for formulations of SMS (Septon 8006), SIBS and polypropylene plasticized with PIB oil.

TABLE 2

| Ingredient, % | A2 | B2 | C2 | D2 | E2 | F2 |
|---|---|---|---|---|---|---|
| Septon 8006 | | | 31.7 | 28.1 | 17.8 | 20. |
| Indopol H-300 | | 31.7 | 50.8 | 45.0 | 28.5 | 32 |
| F040 polypropylene | | 4.2 | | | | |
| melt flow 4 | | | | | | |
| Atofina 3622 PP | | | 17.1 | 16.9 | 17.8 | 8. |
| melt flow 12 | | | | | | |
| Sibstar ® 103T-F | 100 | 63.4 | 0.0 | 9.8 | 35.7 | 40. |
| Irganox 1010 | | 0.1 | | 0.1 | | 0.1 |
| DLDTP antioxidant | | 0.1 | 0.1 | 0.1 | 0.1 | 0.1 |
| Kemamide U | | 0.5 | 0.3 | | | |
| Hardness, Shore A | 49 | 38 | 63 | 58 | 64 | 42 |
| O₂ Permeation | 3900 | 4500 | 16500 | 11000 | 6200 | 6100 |
| rate, cc.(2.54 μm)/m² · day · atm | | | | | | |

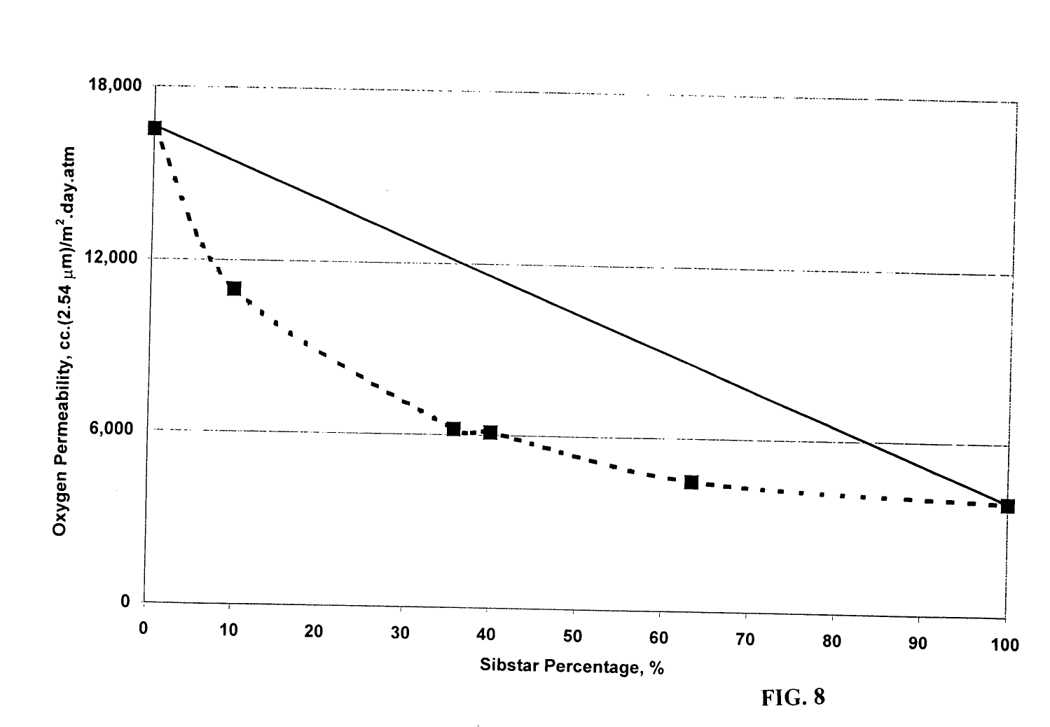

Permeation rates of the foregoing formulations are plotted in FIG. 8. What one might expect is represented by the straight line between (i) 100% SIBS at one end; and at the other end, (ii) no (0%) SIBS in the combination of PIB oil, SMS and PP (160 parts PIB oil; 100 parts SMS; 54 parts PP). PP was substituted for HDPE in the blends of FIG. 7 to adjust the viscosity of the blend through the extruder. The varying amounts of Septon® 8006 SMS are added because the other physical properties of the SIBS and PIB oil combination without the SMS do not have comparable hardness.

It is evident from FIG. 8 that when the PIB oil (H-300) is present in the range from about 5% to 90% the oxygen permeation rate is not directly related to, but substantially lower than the expected rate indicated by the straight line between the end-points of the curve. In particular, from about 10-75% by weight of SIBS plasticized with PIB oil shows a large improvement in barrier properties, that is, lower oxygen permeability.

The following Table 3 sets forth the relative amounts of ingredients of ten formulations A3-J3 as a percentage of the finished blend, each formulation with varying amounts of PIB oil (H-300) and providing comparable, desirable hardness. Formulations A3, B3 and C3 are made with SMS (Septon 8006) as the only rubber. Formulations G3, H3 and I3 are made with uncrosslinked butyl rubber (95% isobutylene, 5% isoprene) commercially available from Brandywine as PA 20 and Septon 8006. In formulation J3, Septon 8006 is combined with a butyl TPV commercially available from AES as Trefsin 3101-65W305.

Comparing D3 and G3, it is seen that each has the same amount of rubber (10.4% in the blend) other than Septon 8006; and the uncrosslinked butyl rubber provides essentially the same oxygen permeability, but for G3 the compression set at 70° C. is 75%, versus that for D3, namely 55%. The higher compression set results in localized creep, and an unacceptably high removal torque making it too difficult to remove a cap, having a G3 cap liner, from the mouth of a bottle. The problem with G3 is exaggerated in H3, I3 and J3, though each has desirably low oxygen permeability. Most preferred hardness for the novel sealant is in the range from about Shore A 50 to 70 with a compression set in the range from 50-70% at 70° C. after 22 hr.

TABLE 3

| Ingredient, % | A3 | B3 | C3 | D3 | E3 | F3 | G3 | H3 | I3 | J3 |
|---|---|---|---|---|---|---|---|---|---|---|
| Septon 8006 | 34.9 | 34.6 | 31.35 | 29.76 | 20.37 | 17.64 | 29.76 | 20.37 | 17.64 | 19.57 |
| Indpol H-300 | 45.35 | 44.99 | 50.16 | 41.66 | 28.51 | 28.22 | 41.66 | 28.51 | 28.22 | 31.31 |
| F040 (Melt Flow 4) | 18.84 | 18.68 | 16.93 | | | | | | | |
| Atofina 3622 (Melt Flow 12) | | | | 17.85 | 20.37 | 17.64 | 17.85 | 20.36 | 17.64 | 19.57 |
| Butyl TPV | | | | | | | | | | 29.35 |
| Uncrosslinked Butyl Rubber | | | | | | | 10.4 | 30.55 | 35.28 | |
| Sibstar 103T-F, SIBS Polymer | | | | 10.4 | 30.55 | 35.28 | | | | |
| Dow Corning 200 | | 2.33 | 0.68 | 0.3 | 0.2 | 0.2 | 0.2 | 0.2 | 0.2 | 0.2 |
| Irganox 1010 | 0.05 | 0.05 | 0.047 | | | | | | | |
| DLTDP antioxidant | 0.1 | 0.1 | 0.1 | | | | | | | |
| Kemamide U | 0.757 | 0.751 | 2.17 | | | | | | | |
| Hardness, Shore A | 72 | 72 | 61 | 62 | 66 | 62 | 64 | 69 | 66 | 71 |
| Oxygen Permeation, | 15800 | 15800 | 12500 | 11000 | 8000 | 6200 | 10500 | 7800 | 6050 | 6650 |
| cc.25.4 μm/m² · day · atm | | | | | | | | | | |
| Compression Set % @ | 23 | 21 | 20 | 23 | 21 | 22 | 29 | 32 | 37 | 37 |
| 23° C./22 hr. | | | | | | | | | | |
| Compression Set @ | 59 | 58 | 63 | 55 | 62 | 69 | 75 | 98 | 98 | 98 |
| 70° C./22 hr. | | | | | | | | | | |

The following Table 4 sets forth ratios of the amount of PIB oil to total rubber in each blend A3-F3; and the ratio of PIB oil to Septon 8006 in blends A3-C3; and, the ratio of PIB oil to Sibstar 103T-F in each novel blend D3-F3.

TABLE 4

| Ratio | A3 | B3 | C3 | D3 | E3 | F3 |
|---|---|---|---|---|---|---|
| PIB oil/Total rubber | 1.3 | 1.3 | 1.6 | 1.037 | 0.697 | 0.50 |
| PIB oil/Sibstar 103T-F | | | | 4.0 | 0.933 | 0.933 |
| PIB oil/Septon 8006 | 1.3 | 1.3 | 1.6 | 1.4 | 1.4 | 1.6 |
| Sibstar/total rubber | | | | 0.26 | 0.6 | 0.66 |
| Total rubber/polyolefin | 1.85 | 1.85 | 1.85 | 2.25 | 2.5 | 3.0 |
| Hardness, Shore A | 72 | 72 | 61 | 62 | 66 | 62 |
| cc.25.4 μm/m² · day · atm | 15800 | 15800 | 12500 | 11000 | 8000 | 6200 |

Comparing C3 and D3 above, it is evident that less polyolefin in total rubber provides slightly higher hardness and better barrier properties; and a higher ratio of PIB oil to rubber in D3 provides better barrier properties. In E3 and F3 it is evident that even better barrier properties are obtained with higher ratios of total rubber to polyolefin without substantially raising the hardness because there is more PIB oil present. Most preferred ratio of PIB oil/SIBS is in the range from about 0.75 to 4.5.

In Table 5 below is set forth two formulations, each containing the same amount of a different polyolefin, each particularly suitable as a core layer sandwiched between polyolefin films, the effect of which is measured on oxygen permeability. If higher hardness less than Shore A 80 is desired, it may be provided by extending the blends with additional polyolefin. The rubbers being miscible provide a single rubber phase in an interpenetrating network with the polyolefin.

TABLE 5

| Ingredient | A5 phr | A5 % | B5 phr | B5 % |
|---|---|---|---|---|
| Kraton MD6932 | 50 | 23.2 | 50 | 23.2 |
| Indopol H-300 | 40 | 18.6 | 40 | 18.6 |
| Alathon L5045 HDPE | 25 | 11.6 | | |
| (0.45 MFI) | | | | |
| Hunstman 43S2A PP | | | 25 | 11.6 |
| (2 MFI) | | | | |
| Sibstar ® 102T | 100 | 46.5 | 100 | 46.5 |
| Ethanox 330 | 0.2 | 0.1 | 0.2 | 0.1 |
| Ratio | 0.67 | | 0.67 | |
| Sibstar/total rubber | | | | |
| Ratio | 0.267 | | 0.267 | |
| PIB oil/total rubber | | | | |
| Ratio | 0.4 | | 0.4 | |
| PIB oil/Sibstar | | | | |
| Ratio | 0.8 | | 0.8 | |
| PIB oil/Kraton | | | | |
| Ratio | 6.0 | | 6.0 | |
| total rubber/polyolefin | | | | |
| Ratio | 0.5 | | 0.5 | |
| Sibstar/polyolefin | | | | |
| Total phr or % | 215.2 | 100 | 215.2 | 100 |
| Hardness, Shore A | 63 | | 65 | |
| O₂ Permeation rate, | 5,400 | | 5,500 | |
| cc.(2.54 μm)/m² · day · atm | | | | |

As evident from the above data, the different polyolefins having MFI in the range from 0.45 to 2, used in the same ratios, do not have a substantial effect on the oxygen permeability. The preferred hardness for a core layer is in the range from about Shore A 35-70, and desired hardness, even if higher, may be provided by choosing the MFI and amount of olefin used to adjust the ratio of total rubber/polyolefin in the range from about 0.5 to 10 depending upon the physical properties of the rubber used.

In the '070 application, presented in Table 1, were four detackified formulations (i)-(iv), plasticized with H300, which contained the following percentages of Septon 8006 rubber in relation to combined rubber and Panalene H-300 PIB oil: (i) 100/230=0.434; (ii) 100/240=0.42; (iii) 100/260=0.385; and (iv) 100/270=0.37. The formulations had the following corresponding oxygen permeation rates: (i) 15,800; (ii) 13,800; (iii) 12,500; and, (iv) 11,100. When plotted as “% Septon 8006 rubber” (on the x-axis) versus “oxygen permeation rate” (on the y-axis), and joining points (i) and (iv) with a straight line, it is seen that points (ii) and (iii) fall close to the line but on opposite sides of it, indicating that the permeation rate as a function of the amount of Septon 8006 in PIB oil is reasonably predictable, unlike that of a combination of SIBS (Sibstar) and SMS ( Septon 8006).

In a laboratory procedure for preparing the basic blend, 1 Kg of Septon 8006 flake and the desired amount of Sibstar pellets are poured into a Henschel high intensity mixer and mixing started. While mixing, the desired amount of PIB oil is gradually uniformly dispersed throughout the mass of flakes and sorbed into them over a period of about 2 mins so that they are not oily to the touch. The polyolefin hardener and optionally, the remaining ingredients including a useful-life enhancing additive, non-reinforcing non-reactive filler, stabilizer, processing aid, antiblocking aid, antistatic agent, wax, foaming agent, pigment, and flame retardant, are then added and mixing continued for about an additional 3 min to ensure that the ingredients are homogeneously distributed in the rubber and the temperature of the mass is in the range from about 70° C. to 120° C.

The mass of elastomer flakes are fed to the hopper of a Leistritz LSM 34 twin-screw extruder having a 34 mm diameter screw and a L/D ratio of 34. Three zones are maintained in the barrel to melt-blend and extrude the elastomer. The temperature in the first zone ranges from 150° C. to 190° C.; in the second zone from 160° C. to 210° C.; and in the third zone from 190° C. to 220° C. The time during which the blend stayed in the barrel ranges from about 1 min to 10 min.

Permeability of a thin molded plaque of film to oxygen is measured in an Oxtran 2/20 instrument made by Mocon Co. A plaque 1250 mm×1500 mm, 0.7 mm thick is molded from a sample of a blend for which permeability is to be measured. All testing is carried out at 23° C. and 0% relative humidity (RH), unless the transmission rate is desired for water vapor; in that case the RH is 90%. Pure nitrogen is flowed over one (first) face of the plaque and pure oxygen is flowed over the opposite (second) face. The effluent nitrogen from the second face is led through an oxygen detector which quantifies the concentration of oxygen. After sufficient time has elapsed for the concentration of oxygen to reach an equilibrium value, the concentration of oxygen at equilibrium is used to compute the volume which would flow through a 1 mil (25.4 μm) thick plaque during 24 hr at 1 atm. All tests for permeability reported hereunder are carried out at 23° C. and 0% RH.

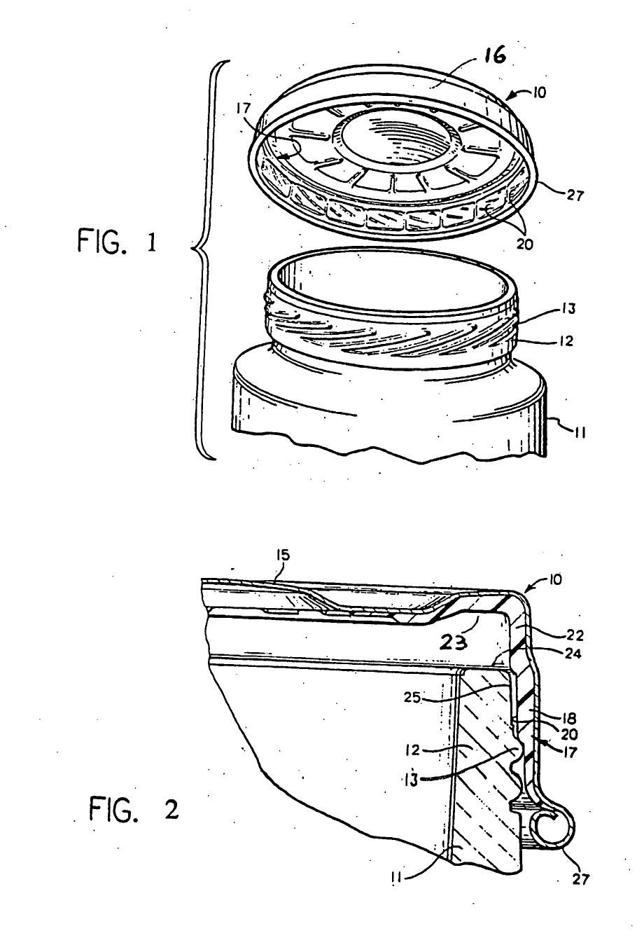

Referring to FIGS. 1 and 2 there is illustrated a conventional cap 10 for a bottle 11 having a mouth defined by a cylindrical wall 12 which is threaded on its outer surface. The cap is made of metal and includes a base wall 15 and a peripheral wall 16 having a rolled flange with a rolled end 27 at its free end. A gasket 17 of the novel PIB-plasticized blend is cast in situ and extends along the inner surface of the wall 16 which is threaded tightly fitted to the mouth of the bottle. The annular portion 18 of the gasket provides an effective seal against leakage, and a comparable seal may be provided if the thickness of the gasket at 20 is such that the surface 20 bears against the outer surface 25 of the bottle. Any oxygen permeating through the gasket is required to traverse the vertical distance between the point of contact at 13 and the periphery of the mouth of the bottle. The vertical section 22 may be foreshortened so that the inner surface 23 of the upper portion of the gasket lies against the horizontal upper surface 24 of the mouth.

Alternatively, a conventional cap liner may be in-shell-molded using the PIB-plasticized SMS, SIBS and polyolefin blend and substituted for the gasket so that the cap liner is tightly secured against the horizontal upper surface 24 of the mouth.

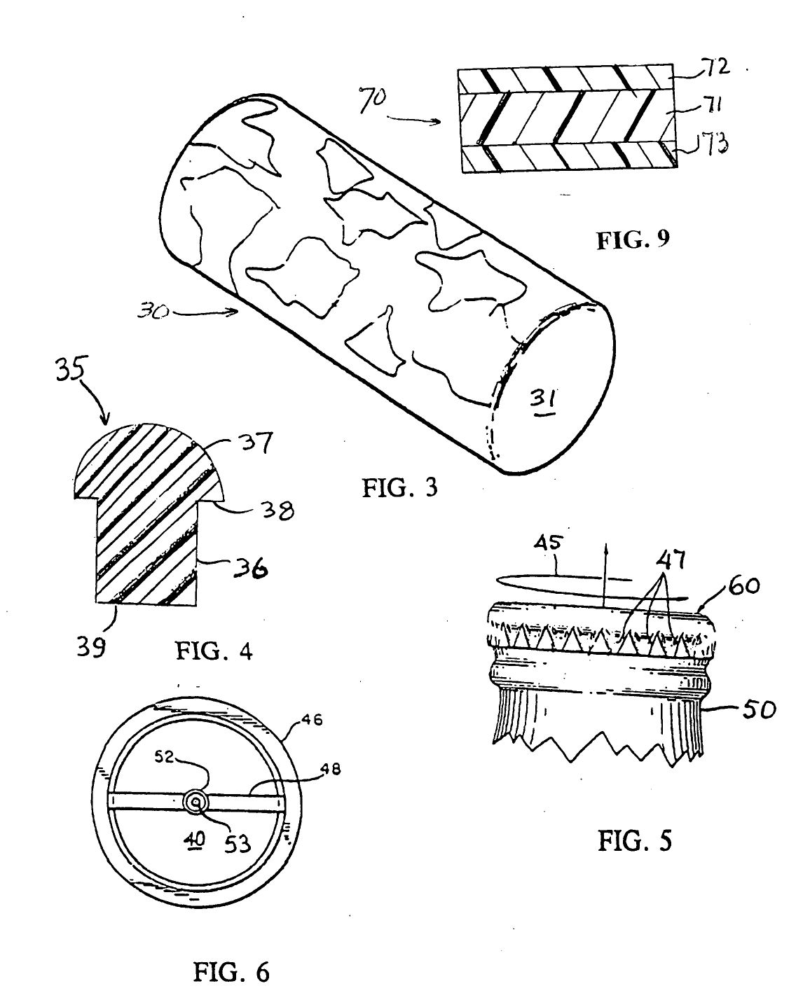

Referring to FIG. 3 there is illustrated a generally cylindrical plug, indicated generally by reference numeral 30, molded to tightly fit in the mouth of a bottle (not shown) so that one end-face 31 of the plug may be exposed to the atmosphere while the opposed end-face (not shown) will contact the contents of the bottle. The cork may be mottled to give the appearance of natural cork, by mixing differently pigmented PIB-plasticized SMS, SIBS and polyolefin blends.

Illustrated in FIG. 4 is another conventional “cork” 35 molded from a PIB-plasticized SMS, SIBS and polyolefin blend to have a generally cylindrical or slightly tapered plug portion 36 and a generally hemispherical cap portion 37 at one end of the plug portion. The off-set 38 of the base of the cap portion on either side of the plug portion 36 is adapted to overlie the horizontal surface of the rim (not shown) of the bottle to be stoppered. The face 39 of the plug portion may be of larger diameter than the distal portion of the plug so as to provide a taper, if desired.

Referring to FIGS. 5 and 6 there is illustrated a conventional syringe vial having a neck 50 to which a metal closure 60 is tightly secured. The metal closure is a ring 46 having pendant serrations 47 in uniformly spaced-apart relationship with each other around the entire periphery of the ring. Diametrically opposite portions of the ring are connected with a metal strip 48 in which is provided a disc 52 having an aperture 53 in it. A generally cylindrical septum 40 about 1 mm thick, formed of the novel PIB-plasticized SMS, SIBS and polyolefin blend, is tightly held near its periphery, between the ring 46 and the surface of the rim of the vial, when the ring is deformed around the mouth of the vial and the serrations pressed tightly inwardly against the neck 50. A needle of a hypodermic syringe may be readily inserted through the aperture 53 and the septum 40 to withdraw contents of the vial. A twisting motion in the horizontal plane, as illustrated by the arrow 45 on the ring can loosen the ring sufficiently to remove the metal closure 60 in the vertical direction.

FIGS. 7 and 8 have been described hereinabove.

FIG. 9 is a cross-sectional view of a composite 70 of a core layer 71 in the range from about 10 μm-77 μm thick, to each side of which is bonded skin layers 72 and 73 of a polyC₂-C₃olefin and copolymers thereof, each skin layer in the range from about 10 μm to 25.4 μm, and the core layer and skin layers are preferably co-extruded. Each layer is substantially transparent and cumulatively have a haze from about 1% to 25%. The cumulative haze depends upon the haze of each layer which in turn depends upon the thickness of each skin layer the molecular weight of the polymers in each layer.

By “substantially transparent” is meant that the molded composition has substantially no haze, that is, less than 15%, typically from 5%-10%, for a plaque 77μm (3 mils) thick, measured with a BYK Gardner Micro Tri-gloss 4525 meter and ASTM D1003 test procedure. Haze below 15% permits a “see-through” property sufficient to allow one to read black letters printed in 14 point font on a white surface through a thickness of sealant about 77 μm, held 5 cm away from the surface.

The polyolefin is chosen from polypropylene and polypropylene copolymers having less than 10% of a comonomer other than propylene, low density and high density polyethylene, ethylene copolymers having less than 10% of a comonomer other than ethylene, polybutene, and butene ethylene copolymers in which ethylene is present in an amount less than 10%, each of the foregoing having a density in the range from about 0.93 to 0.98 g/cc. Most preferred are polypropylene and polyethylene.

The composite film is adapted for use in a flexible container, such as an I-V bag, formed by bonding two superimposed composite skin layers at their peripheral edges with openings for filling the bag with fluid and dispensing the fluid.

Having described the blend using the SIBS copolymer as an essential component with SMS and a polyolefin, and plasticized with PIB oil, in the overall process of making and using the blend, and having illustrated the best mode with specific examples of how the blend provides products which effectively seal a container against gas-leakage either into or out of the container, it will be evident that the novel blend may be used in a wide choice of combinations depending upon the demands of a particular application; and, that the novel blend provides an economical and effective solution to a difficult problem. It is therefore to be understood that no undue restrictions are to be imposed by reason of the specific embodiments illustrated and discussed, and particularly that the invention is not restricted to a slavish adherence to the details set forth herein.

I claim:

1. An oil-plasticized sealant against diffusion of oxygen, the sealant consisting essentially of a thermoplastic, melt-processable, elastomer esentially free of a detackifier and butyl rubber, yet essentially free of tackiness and of oil bleed, the sealant consisting essentially of an essentially homogeneous blend of
(A) a substantially fully hydrogenated vinylaromatic-conjugated diene block copolymer (SMS) having a number average molecular weight (“Mn”) in the range from about 40,000 to 500,000;
(B) a solid polystyrene-polyisobutylene-polystyrene (SIBS) block copolymer having a Mn in the range from about 50,000 to 500,000 and styrene/isobutylene present in a weight ratio in the range from 5/95 to 37/63;
(C) liquid polyisobutylene (PIB) oil having a number average molecular weight (“Mn”) in the range from 200 to 6000, the polyisobutylene selected from the group consisting of (i) a homopolymer of polyisobutylene and (ii) a copolymer of isobutylene and butylene, butylene repeating units being present in a minor molar proportion;
(D) a homopolymer of ethylene or propylene in an amount in the range from about 5% to 35% by weight; and,
(E) an additive, known in the art to enhance the useful life of the sealant, in an amount less than 5% by weight of the plasticized sealant;
the polyisobutylene oil and SIBS block copolymer each being present in a minor amount by weight relative to the weight of the plasticized sealant;
the plasticized sealant having a hardness in the range from about Shore A 35 to less than 80, and an oxygen permeation rate less than 12,000 cc.(2.54 μm)/m².day.atm at 23□C.

2. The sealant of claim 1 having a compression set in the range from 40-70% @ 70° C./22 hr, wherein the polyethylene has a melt flow index (MFI) in the range from about 0.2-100 gm/10 min at 230□C and 2.16 Kg load, and the polypropylene has a MFI in the range from about 1 -200 gm/10 min at 230□C and 2.16 Kg load; and the weight ratio of PIB oil/SIBS is in the range from 0.3 to 5.

3. The sealant of claim 2 wherein (A) includes a midblock selected from the group consisting of hydrogenated poly(isoprene), hydrogenated poly(butadiene), and mixtures thereof in heterogeneous relative order.

4. The sealant of claim 2 having hardness in the range from Shore A 50 to 70; a weight ratio of PIB oil/blended sealant in the range from about 10% to 45%; compression set in the range from 15-25% @ 23° C./22 hr, and 50-70% @ 70° C./22 hr; thickness in the range from 0.1 mm to 10 mm; and, oxygen permeation rate in the range from 5,000-8,000 cc/m².day; wherein the polyethylene has a MFI in the range from 0.5 to 50 gm/10 min at 23□C and 2.16 Kg load; and, polypropylene has a MFI in the range from 2 to 100 gm/10 min at 23□C and 2.16 Kg load.

5. The sealant of claim 4 wherein the midblock in (A) is selected from the group consisting of (i) ethylene-butylene; (ii) ethylene-propylene; and (iii) ethylene-ethylene-propylene.

6. The sealant of claim 5 having homogeneously distributed therewithin an additive selected from the group consisting of a non-reinforcing non-reactive filler, stabilizer, processing aid, antiblocking aid, antistatic agent, lubricant, wax, foaming agent, pigment, and flame retardant.

7. The sealant of claim 6 wherein the PIB oil is present in the range from 20-45%, and the sealant has a weight ratio of (i) PIB oil/total rubber in the range from about 0.2 to 1.5; (ii) SIBS/total rubber in the range from about 0.2 to 0.75; and, (iii) PIB oil/SIBS in the range from about 0.3 to 5.

8. The sealant of claim 7 having a haze index in the range from 1 to less than 25.

9. A closure means for sealing a container against permeation of an oxygen-containing gas against leakage of a gas under pressure in the range from about 1 to 3 atm (or bar) comprising an elastomeric plasticized sealant held in removably sealing relationship to form the closure means, the sealant being essentially free of oil bleed and tack and having a thickness in the range from about 0.1 mm to about 10 mm, the sealant consisting essentially of an essentially homogeneous blend of
(A) a substantially fully hydrogenated vinylaromatic-conjugated diene block copolymer (SMS) having a number average molecular weight (“Mn”) in the range from about 40,000 to 500,000;
(B) a solid polystyrene-polyisobutylene-polystyrene (SIBS) block copolymer having a Mn in the range from about 50,000 to 500,000 and styrene/isobutylene present in a weight ratio in the range from 5/95 to 37/63;
(C) liquid polyisobutylene (PIB) oil having a number average molecular weight (“Mn”) in the range from 200 to 6000, the polyisobutylene selected from the group consisting of (i) a homopolymer of polyisobutylene and (ii) a copolymer of isobutylene and butylene, butylene repeating units being present in a minor molar proportion;
(D) a homopolymer of ethylene or propylene in an amount in the range from about 5% to 35% by weight; and,
(E) an additive, known in the art to enhance the useful life of the sealant, in an amount less than 5% by weight of the plasticized sealant;
the polyisobutylene oil and SIBS block copolymer each being present in a minor amount by weight relative to the weight of the plasticized sealant;
the plasticized sealant having a hardness in the range from about Shore A 35 to less than 80, and an oxygen permeation rate less than 12,000 cc.(2.54 μm)/m².day.atm at 23□C.

10. The closure means of claim 9 wherein the sealant has a compression set in the range from 40-70% @ 70° C./22 hr.

11. The closure means of claim 10 wherein the sealant has a haze index in the range from 1 to less than 25.

12. The closure means of claim 10 wherein the closure means is a bottle cap and the container is a bottle.

13. The closure means of claim 10, wherein the closure means is a stopper and the container is a bottle.

14. A composite film comprising (i) a core layer of plasticized essentially tack free sealant, essentially free of oil bleed, and (ii) a skin layer bonded to each side of the core layer, the composite film having a haze in the range from 1 to less than 25, wherein (i) consists essentially of
(A) a substantially fully hydrogenated vinylaromatic-conjugated diene block copolymer (SMS) having a number average molecular weight (“Mn”) in the range from about 40,000 to 500,000;
(B) a solid polystyrene-polyisobutylene-polystyrene (SIBS) block copolymer having a Mn in the range from about 50,000 to 500,000 and styrene/isobutylene present in a weight ratio in the range from 5/95 to 37/63;
(C) liquid polyisobutylene (PIB) oil having a number average molecular weight (“Mn”) in the range from 200 to 6000, the polyisobutylene selected from the group consisting of (i) a homopolymer of polyisobutylene and (ii) a copolymer of isobutylene and butylene, butylene repeating units being present in a minor molar proportion;
(D) a homopolymer of ethylene or propylene in an amount in the range from about 5% to 35% by weight; and,
(E) an additive, known in the art to enhance the useful life of the sealant, in an amount less than 5% by weight of the plasticized sealant;
the polyisobutylene oil and SIBS block copolymer each being present in a minor amount by weight relative to the weight of the plasticized sealant;
the core layer (i) having a hardness in the range from about Shore A 35-<80, and an oxygen permeation rate less than 12,000 cc.(2.54 μm)/m².day.atm at 23□C; and, each skin layer (ii) consists essentially of a polyC₂-C₃olefin and copolymers thereof, the core layer and each skin layer having a haze less than 25%.

15. A method for providing an essentially oxygen-impermeable elastomeric sealant comprising,
melt-blending at a temperature in the range from about 150° C. to 250° C.,
(A) a substantially fully hydrogenated vinylaromatic-conjugated diene block copolymer (SMS) having a number average molecular weight (“Mn”) in the range from about 40,000 to 500,000;
(B) a solid polystyrene-polyisobutylene-polystyrene (SIBS) block copolymer having a Mn in the range from about 50,000 to 500,000 and styrene/isobutylene present in a weight ratio in the range from 5/95 to 37/63;
(C) liquid polyisobutylene (PIB) oil having a number average molecular weight (“Mn”) in the range from 200 to 6000, the polyisobutylene selected from the group consisting of (i) a homopolymer of polyisobutylene and (ii) a copolymer of isobutylene and butylene, butylene repeating units being present in a minor molar proportion;
(D) a homopolymer of ethylene or propylene in an amount in the range from about 5% to 35% by weight; and,
(E) an additive, known in the art to enhance the useful life of the sealant, in an amount less than 5% by weight of the plasticized sealant;
the polyisobutylene oil and SIBS block copolymer each being present in a minor amount by weight relative to the weight of the plasticized sealant;
the plasticized sealant having a hardness in the range from about Shore A 35 to less than 80, and an oxygen permeation rate less than 12,000 cc.(2.54 μm)/m².day.atm at 23□C.
